(19) United States
(12) Patent Application Publication
(10) Pub. No.: US 2018/0112998 A1
(43) Pub. Date: Apr. 26, 2018

(54) Navigation advertisement pushing system based on geographic positions

(71) Applicant: Junhua Xue, Yangzhou, Jiangsu (CN)

(72) Inventor: Junhua Xue, Yangzhou, Jiangsu (CN)

(21) Appl. No.: 14/917,014

(22) PCT Filed: Jan. 4, 2016
(86) PCT No.: PCT/CN2016/070038

§ 371 Date: Jan. 2, 2018

(51) Int. Cl. G01C 21/36; G01C 21/34

(52) U.S. Cl. CPC G01C 21/3697; G01C 21/3484

(57) ABSTRACT

A navigation advertisement pushing system based on geographic positions includes: a server, a plurality of navigation terminals and users corresponding to the navigation terminals, wherein: the server includes a database having a map and a track layer corresponding to the map. The track layer is divided into each storage unit which corresponds to each geographic region of the map. The server receives positioning data and a corresponding time, uploaded by each navigation terminal, confirms the storage unit which a geographic position of the navigation terminal corresponds to, and stores a username of the navigation terminal and the time into the storage unit. The user inputs a pushing region through the navigation terminal to generate a navigation advertisement; the server receives the navigation advertisement, calculates out relevant users with user track data in the storage unit corresponding to the pushing region, and sends the navigation advertisement to the relevant users.

### CROSS REFERENCE OF RELATED APPLICATION

This is a U.S. National Stage under 35 U.S.C 371 of the International Application PCT/CN2016/070038, filed Jan. 4, 2016.

### BACKGROUND OF THE PRESENT INVENTION

### Field of Invention

The present invention relates to a navigation advertisement pushing system based on geographic positions, and more particularly to a navigation advertisement pushing system capable of tracking and charging separately after pushing an advertisement.

### Description of Related Arts

Most of the conventional solutions for storing, replaying and tracking the user tracks are that the system collects the positioning coordinates of the user in real-time and stores the positioning coordinates into the storage unit in the database corresponding to the user, in the order of the time of collecting the positioning coordinates. For a navigation advertisement pushing system of the present invention, a server needs to calculate and analyze historical track data of users and screen out appropriate advertisement pushing objects from all the users. Based on the conventional coordinates data storage structure, in order to calculate and screen out relevant users for a specific geographic region, the server of the navigation advertisement pushing system has to calculate Global Positioning System (GPS) tracks of all the users, which is a huge calculation load for the server. Especially after the number of the users increases enormously, every time the server finishes screening out the mission affiliates, the calculation load wasted on irrelevant track data greatly increases. Therefore, it is necessary to provide a user track data storage structure for effectively filtering off the track data which are irrelevant to pushing the advertisement, so as to reduce the calculation load of the server and adapt to the continuous growth in the number of the users.

The inventor of this application disclosed two interactive dynamic cloud navigation systems, respectively in the U.S. Pat. No. 9,127,951 and the PCT international application PCT/CN2015/088812. Due to the conventional coordinate data storage structure, in the two conventional interactive dynamic cloud navigation systems, the servers also have a great calculation load when screening out the mission affiliates.

The conventional internet advertisements, available on the market, are mostly charged based on the advertisement click amount or the number of users pushed with the advertisements. After pushing the advertisement or the click on the advertisement, the system fails to track the consumption behavior of the user, which brings a great advertisement investment risk to the advertisers; such tracking is necessary.

Furthermore, in some conventional technical solution which automatically updates the roads network data on the map according to the user tracks, the conventional technical solution simply equates the user tracks with the roads and is liable to add the wrong tracks into the map public roads network. For example, the wrong tracks can be the mountain-climbing tracks of tour pals, or the movement tracks within private lands.

### SUMMARY OF THE PRESENT INVENTION

An object of the present invention is to provide a navigation advertisement pushing system based on geographic positions, for pushing an advertisement, analyzing track features of users after the users receive the advertisement and charging separately, so as to reduce advertisement investment risk.

Another object of the present invention is to provide a user track storage structure for reducing a calculation load on a server in calculating and screening out advertisement pushing objects.

Another object of the present invention is to provide the navigation advertisement pushing system based on the geographic positions, for supplementing a map with roads network data. The navigation advertisement pushing system analyzes user historical tracks based on the user track storage structure, and judges whether a track of the user within a region is a public road or not by calculating out a number of the users who pass through the region or person-times of the users who pass through the region.

Accordingly, in order to accomplish the above objects, the present invention provides a navigation advertisement pushing system based on geographic positions, comprising:

a server, a plurality of navigation terminals and a plurality of users corresponding to the plurality of the navigation terminals, wherein: each navigation terminal comprises a data collection module, a first data storage module, a first data transmission module and a first input and output module; the data collection module is for collecting positioning data of the navigation terminal and a time corresponding to the positioning data in real-time; the first data storage module is for storing data; the first data transmission module is for transmitting data between the navigation terminal and the server; the first input and output module is for receiving an input of the user and outputting to the user the data stored by the navigation terminal;

the server comprises a database which has a map, a track layer for storing user track data, corresponding to the map, and a plurality of accounts corresponding to the plurality of the users, wherein: each user logs on the corresponding account on the server with the corresponding navigation terminal; each account comprises a username and account credits, wherein the username is a unique identification of the account on the server; the track layer is divided into a plurality of storage units according to the map, in such a manner that each storage unit corresponds to a geographic region of the map; with the data collection module and the first data transmission module, the server receives the positioning data and the time corresponding to the positioning data which are uploaded by the navigation terminal in real-time, confirms the storage unit which a geographic position of the navigation terminal on the map corresponds to, and stores the username corresponding to the navigation terminal and the time corresponding to the positioning data into the storage unit; the user track data comprises the username of the user corresponding to the navigation terminal and the time;

the navigation terminal is for receiving the input of the user to generate a navigation advertisement, wherein the input of the user comprises coordinates of a pushing region on the map and coordinates of a navigation destination on the map; the server is for receiving the navigation advertisement, calculating and screening out relevant users based on the user track data in the storage unit which the pushing region corresponds to, and sending the navigation advertisement to the relevant users; the relevant users comprise at least one type of the following eleven types:

(1) the users who mark out a familiar region on the map, wherein the familiar region comprises the pushing region;

(2) the users who appear in the pushing region at a frequency higher than a first value;

(3) the users who are appearing at the pushing region exactly at a time of generating the navigation advertisement;

(4) within a time period which is designated by the user who generates the navigation advertisement, the users who are appearing at the pushing region;

(5) the users who appear at the pushing region at times more than a second value;

(6) the users who stay at the pushing region for a time longer than a third value;

(7) the users who appear at the pushing region at a time, wherein a difference between the time when the user appears at the pushing region and the time of generating the navigation advertisement is smaller than a fourth value;

(8) the users whose geographic positions are at a distance to a center of the pushing region, the distance smaller than a fifth value;

(9) the users who appear in the pushing region at a speed slower than a sixth value;

(10) the users who are empowered by the server to become the relevant users of a region, wherein the region comprises the pushing region; and

(11) the users who initiate a data search on a region of the map through the navigation terminal, wherein the region comprises the pushing region;

wherein the first value, the second value, the third value, the fourth value, the fifth value and the sixth value are designated by the user who generates the navigation advertisement.

Preferably, the navigation advertisement pushing system based on the geographic positions further comprises: a plurality of assistant terminals corresponding to the plurality of the users, wherein: each user logs on the corresponding account on the server with the corresponding assistant terminal; each assistant terminal comprises a second data storage module, a second data transmission module and a second input and output module; the second data storage module is for storing data; the second data transmission module is for transmitting data between the assistant terminal and the server; the second input and output module is for receiving the input of the user and outputting to the user the data stored by the assistant terminal; the assistant terminal is for receiving the input of the user to generate the navigation advertisement. A time when the server receives the navigation advertisement is recognized as the time of generating the navigation advertisement.

Preferably, in the storage unit, the server stores the username in an order of the time.

Preferably, in the storage unit, the server stores the time in a category of the username.

Preferably, the server is further for charging the account credits of the user respectively after the server sends the navigation advertisement to the relevant user, after the server detects an arrival of the relevant user at the navigation destination, and after the server calculates out that a duration or times for which the relevant user stays at the navigation destination exceeds or exceed a seventh value, wherein the seventh value is set by the server.

Preferably, the server is further for analyzing user historical movement tracks, counting a number or person-times of the users who pass through a non-road region on the map, and when the number or the person-times exceed a certain value, adding a user movement track within the non-road region into the map to update road data of the map, wherein the certain value is preset by the server.

Preferably, the data collection module is a GPS module; the positioning data are GPS data.

Compared with prior arts, the navigation advertisement pushing system based on the geographic positions, provided by the present invention, has the following benefits. Firstly, the server stores the positioning data and the corresponding time, uploaded by each navigation terminal, into the track layer, so as to constitute the user track data. The server is free from successively calculating user track coordinates user by user, so as to greatly relieve the calculation load of the server in calculating the relevant users. Storage of the user tracks no longer relies on the positioning coordinates of the users. When the user tracks are replayed, the server only needs to linearly connect centers of geographic regions which the storage units where the users are located at different times correspond to in an order of the time, so as to realize replaying the user tracks. Secondly, the navigation advertisement pushing system based on the geographic positions, provided by the present invention, analyzes user behaviors or user consumption based on the movement tracks of the users after receiving the pushed advertisement, and separately charges the account credits for respective times, so as to reduce advertisement investment risk. Thirdly, in supplementing the map with the road data, the navigation advertisement pushing system based on the geographic positions counts the user tracks within the non-road region of the map and calculates the number or the person-times of the users who pass through the non-road region, so as to avoid adding non-public region tracks to the map public roads, such as the tracks of the extreme adventurous tour pal with a low usage frequency and the movement tracks in private lands.

These and other objectives, features, and advantages of the present invention will become apparent from the following detailed description, the accompanying drawings, and the appended claims.

### BRIEF DESCRIPTION OF THE DRAWINGS

FIG. 1 is a structural sketch view of a navigation advertisement pushing system based on geographic positions according to a first preferred embodiment of the present invention.

FIG. 2 is a structural sketch view of a navigation terminal according to the first preferred embodiment of the present invention.

FIG. 3 is a structural sketch view of an assistant terminal according to the first preferred embodiment of the present invention.

FIG. 4 is a structural sketch view of an account according to the first preferred embodiment of the present invention.

FIG. 5 is a structural sketch view of a navigation advertisement according to the first preferred embodiment of the present invention.

FIG. 6 is a flow chart of pushing an advertisement of the navigation advertisement pushing system based on the geographic positions according to the first preferred embodiment of the present invention.

FIG. 7 is a sketch view of a track layer according to a second preferred embodiment of the present invention.

FIG. 8 is a flow chart of storing positioning data of the navigation advertisement pushing system based on the geographic positions according to the second preferred embodiment of the present invention.

FIG. 9 is a sketch view of a first data storage structure of a storage unit according to the second preferred embodiment of the present invention.

FIG. 10 is a sketch view of a second data storage structure of the storage unit according to the second preferred embodiment of the present invention.

FIG. 11 is a sketch view of splitting the storage unit according to the second preferred embodiment of the present invention.

FIG. 12 is a sketch view of merging the storage units according to the second preferred embodiment of the present invention.

FIG. 13 is a flow chart of supplementing map road data of the navigation advertisement pushing system based on the geographic positions according to the second preferred embodiment of the present invention.

### DETAILED DESCRIPTION OF THE PREFERRED EMBODIMENT

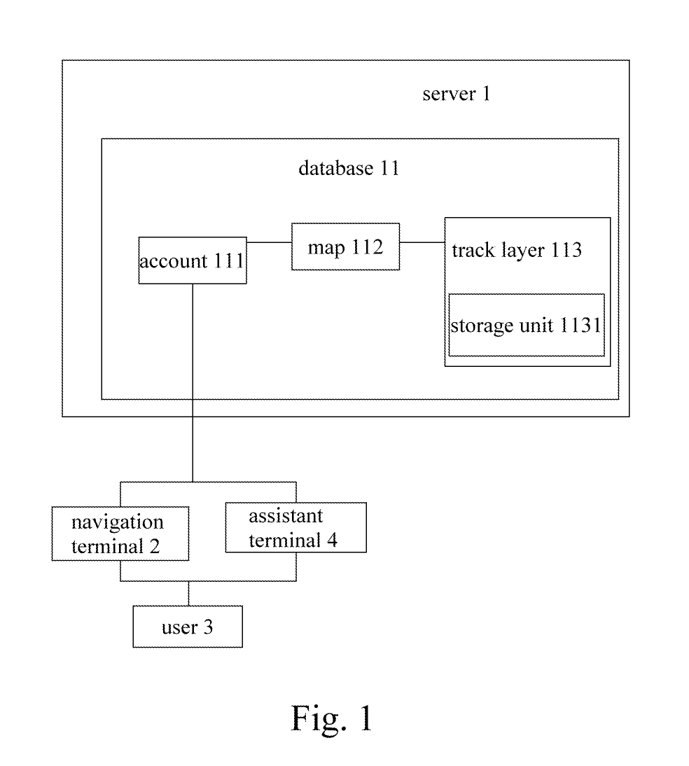

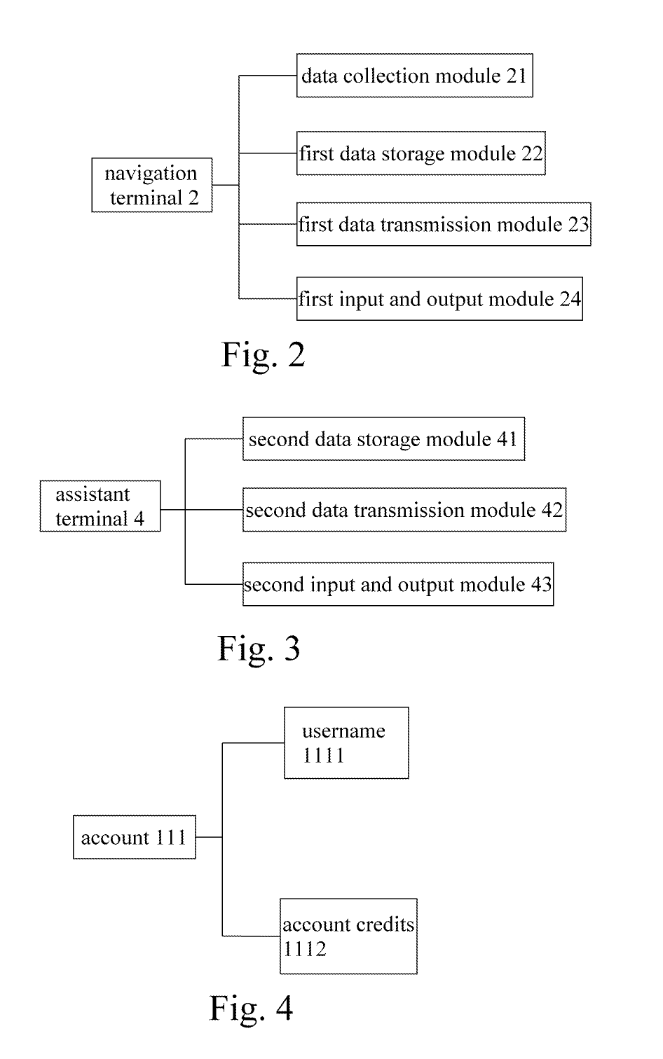

Referring to FIGS. 1-4 of the drawings, according to a first preferred embodiment of the present invention, a navigation advertisement pushing system based on geographic positions comprises:

a server 1, a plurality of navigation terminals 2 and a plurality of users 3 corresponding to the plurality of the navigation terminals 2, wherein: each navigation terminal 2 comprises a data collection module 21, a first data storage module 22, a first data transmission module 23 and a first input and output module 24; the data collection module 21 is for collecting positioning data of the navigation terminal 2 and a time corresponding to the positioning data in real-time; the first data storage module 22 is for storing data; the first data transmission module 23 is for transmitting data between the navigation terminal 2 and the server 1; the first input and output module 24 is for receiving an input of the user 3 and outputting to the user 3 the data stored by the navigation terminal 2; and

a plurality of assistant terminals 4 corresponding to the plurality of the users 3, wherein: each assistant terminal 4 comprises a second data storage module 41, a second data transmission module 42 and a second input and output module 43; the second data storage module 41 is for storing data; the second data transmission module 42 is for transmitting data between the assistant terminal 4 and the server 1; the second input and output module 43 is for receiving the input of the user 3 and outputting to the user 3 the data stored by the assistant terminal 4; wherein:

the server 1 comprises a database 11 which stores a plurality of accounts 111 which correspond to the plurality of the users 3, a map 112, and a track layer 113 for storing user track data, corresponding to the map 112, wherein: each user 3 logs on the corresponding account 111 on the server 1 with the corresponding navigation terminal 2; each user 3 logs on the corresponding account 111 on the server 1 with the corresponding assistant terminal 4; each account 111 comprises a username 1111 and account credits 1112; the track layer 113 is divided into a plurality of storage units 1131 according to the map 112, in such a manner that each storage unit 1131 corresponds to a geographic region of the map 112; with the data collection module 21 and the first data transmission module 22, the server 1 receives the positioning data and the corresponding time, uploaded by each navigation terminal 2, in real-time, confirms the storage unit 1131 which the geographic position of the navigation terminal 2 on the map 112 corresponds to, and stores the username 1111 which the navigation terminal 2 corresponds to and the time which the positioning data corresponds to into the storage unit 1131; the user track data comprise the username 1111 of the user which the navigation terminal 2 corresponds to and the time.

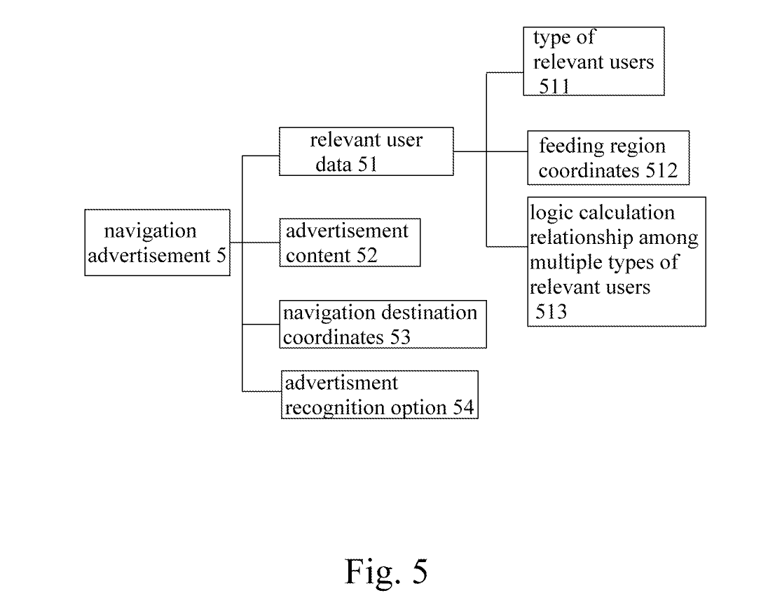

Referring to FIG. 1 and FIG. 5, according to the first preferred embodiment of the present invention, the navigation terminal 2 is for receiving the input of the user 3 to generate a navigation advertisement 5; the assistant terminal 4 is also for receiving the input of the user 3 to generate the navigation advertisement 5. The navigation advertisement 5 comprises: relevant user data 51, advertisement content 52, navigation destination coordinates 53, and an advertisement recognition option 54. The relevant user data 51 comprise a type of the relevant users 511, pushing region coordinates 512, and a logic calculation relationship 513 among multiple types of the relevant users 511. The navigation destination coordinates 53 and the pushing region coordinates 512 respectively correspond to a navigation destination and a pushing region on the map 112. The server 1 is for receiving the navigation advertisement 5 which is uploaded by the navigation terminal 2 or the assistant terminal 4, calculating and screening out the relevant users 31 according to the user track data within the storage unit 1131 which the pushing region corresponds to, and sending the navigation advertisement 5 to the relevant users 31.

The pushing region coordinates 512 are coordinates of a first region, chosen by the user 3 who generates the navigation advertisement 5, on the map 112. The server 1 screens out the relevant users 31 whom the pushing region coordinates 512 correspond to from all the users 3, by calculating the user historical track data, and sends the navigation advertisement 5 to the relevant users 31.

The navigation destination coordinates 53 are coordinates of a second region, also chosen by the user 3 who generates the navigation advertisement 5, on the map 112. The second region is a geographic region of a specific commodity or specific service, provided or displayed by the navigation advertisement 5 for the relevant users 31, and also a geographic region which the relevant users 31 are expected, by the user 3 who generates the navigation advertisement 5, to enter after the relevant users 31 receive the navigation advertisement 5.

The advertisement content 52 is particular advertisement main body displayed by the navigation advertisement 5 towards the relevant users 31. The particular advertisement main body can be texts illustrating a product, sounds or a picture.

The logic calculation relationship 513 comprises AND, OR, NOT and XOR.

The type of the relevant users 511 comprises at least one of the following eleven types:

(1) the users who mark out a familiar region on the map 112, wherein the familiar region comprises the pushing region;

(2) the users who appear in the pushing region at a frequency higher than a first value;

(3) the users who are appearing at the pushing region exactly at a time of generating the navigation advertisement;

(4) within a time period which is designated by the user who generates the navigation advertisement, the users who are appearing at the pushing region;

(5) the users who appear at the pushing region at times more than a second value;

(6) the users who stay at the pushing region for a time longer than a third value;

(7) the users who appear at the pushing region at a time, wherein a difference between the time when the user appears at the pushing region and the time of generating the navigation advertisement is smaller than a fourth value;

(8) the users whose geographic positions are at a distance to a center of the pushing region, the distance smaller than a fifth value;

(9) the users who appear in the pushing region at a speed slower than a sixth value;

(10) the users who are empowered by the server to become the relevant users of a region, wherein the region comprises the pushing region; and

(11) the users who initiate a data search on a region of the map 112 through the navigation terminal, wherein the region comprises the pushing region;

wherein the first value, the second value, the third value, the fourth value, the fifth value and the sixth value are all designated by the user 3 who generates the navigation advertisement 5.

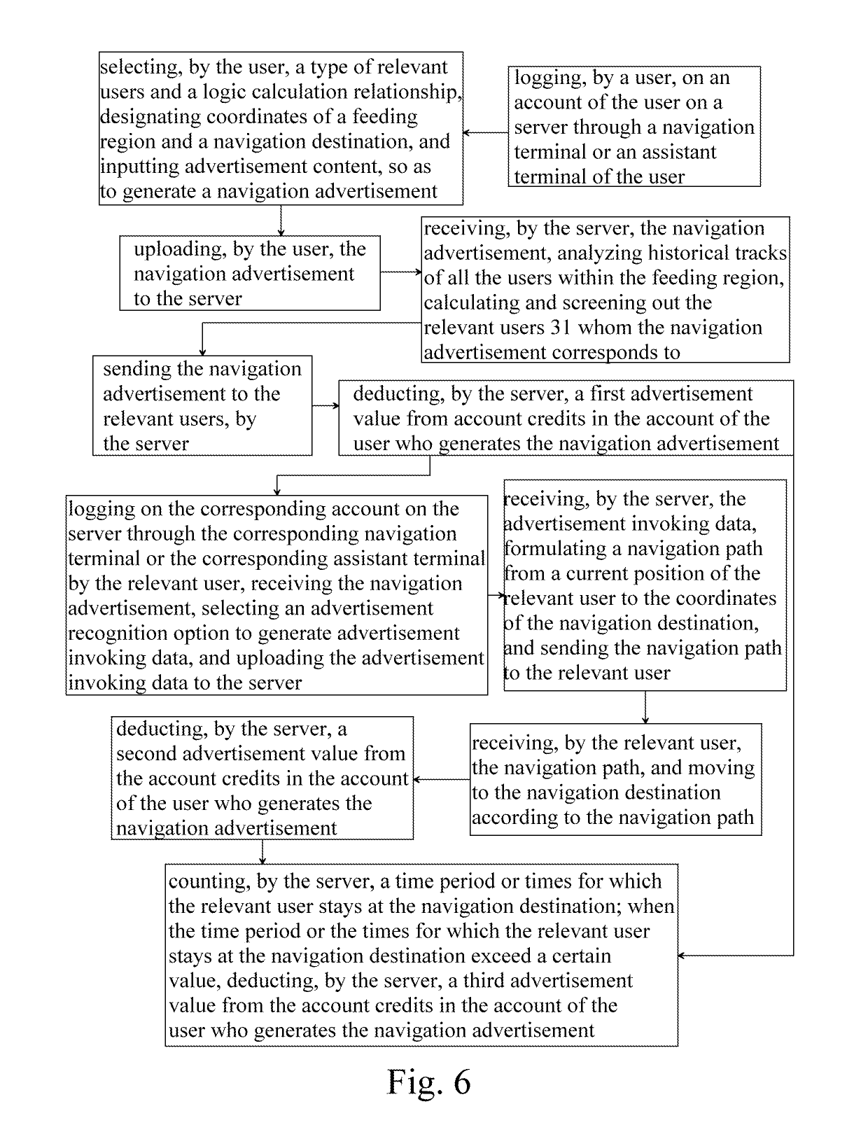

Referring to FIG. 6, according to the first preferred embodiment of the present invention, the navigation advertisement pushing system based on the geographic positions pushes an advertisement, comprising steps of:

(1) logging, by the user 3, on the account 111 of the user 3 on the server 1 with the navigation terminal 2 or the assistant terminal 4 of the user 3; (2) inputting, by the user 3, to the navigation terminal 2 or the assistant terminal 4, comprising: selecting the type of the relevant users 511 and the logic calculation relationship 513, designating the pushing region coordinates 512 and the navigation destination coordinates 53, and inputting the advertisement content 52, so as to generate the navigation advertisement 5; (3) uploading the navigation advertisement 5 to the server 1 by the user 3; (4) by the server 1, receiving the navigation advertisement 5, analyzing the historical track data of the users within the pushing region, calculating and screening out the relevant users 31 whom the navigation advertisement 5 corresponds to; (5) sending the navigation advertisement 5 to the relevant users 31 by the server 1; (6) deducting, by the server 1, a first advertisement value from the account credits 1112 of the user 3; (7) logging, by the relevant user 31, on the account 111 on the server 1 with the navigation terminal 2 or the assistant terminal 4 of the relevant user 31, receiving the navigation advertisement 5, selecting the advertisement recognition option 54 to generate advertisement invoking data, and uploading the advertisement invoking data to the server 1; (8) by the server 1, receiving the advertisement invoking data, formulating a navigation path between the navigation destination coordinates 53 and a current position of the relevant user, and sending the navigation path to the relevant user 31; (9) receiving the navigation path by the relevant user 31, and then moving, by the relevant user 31, to the navigation destination to which the navigation destination coordinates 53 correspond according to the navigation path; (10) deducting, by the server 1, a second advertisement value from the account credits 1112 of the user 3; and (11) counting a duration or times for which the relevant user 31 stays at the navigation destination, by the server 1; when the duration or the times for which the relevant user 31 stays at the navigation destination exceeds or exceed a seventh value, deducting, by the server 1, a third advertisement value from the account credits 1112 of the user 3, wherein the seventh value is preset by the server 1.

The first advertisement value, the second advertisement value, and the third advertisement value, constitute an advertisement value combination. The advertisement value combination is set by the server 1 for different geographic regions or different time periods, for separately charging the account credits 1112 of the user 3 after the server 1 sends the navigation advertisement 5 to the relevant user 31. The first advertisement value is deducted after the server 1 sends the navigation advertisement 5 to the relevant users 31; the second advertisement value is deducted after the relevant user 31 arrives at the navigation destination under the navigation by the server 1; the third advertisement value is deducted after the duration or the times for which the relevant user 31 stays at the navigation destination exceeds or exceed the seventh value.

The server sets the advertisement value combination for the different geographic regions or the different time periods. The advertisement value combination is related to the geographic region where the navigation terminal 2 of the relevant user 31 is located, or related to the time period when the navigation advertisement 5 is sent to the relevant user 31.

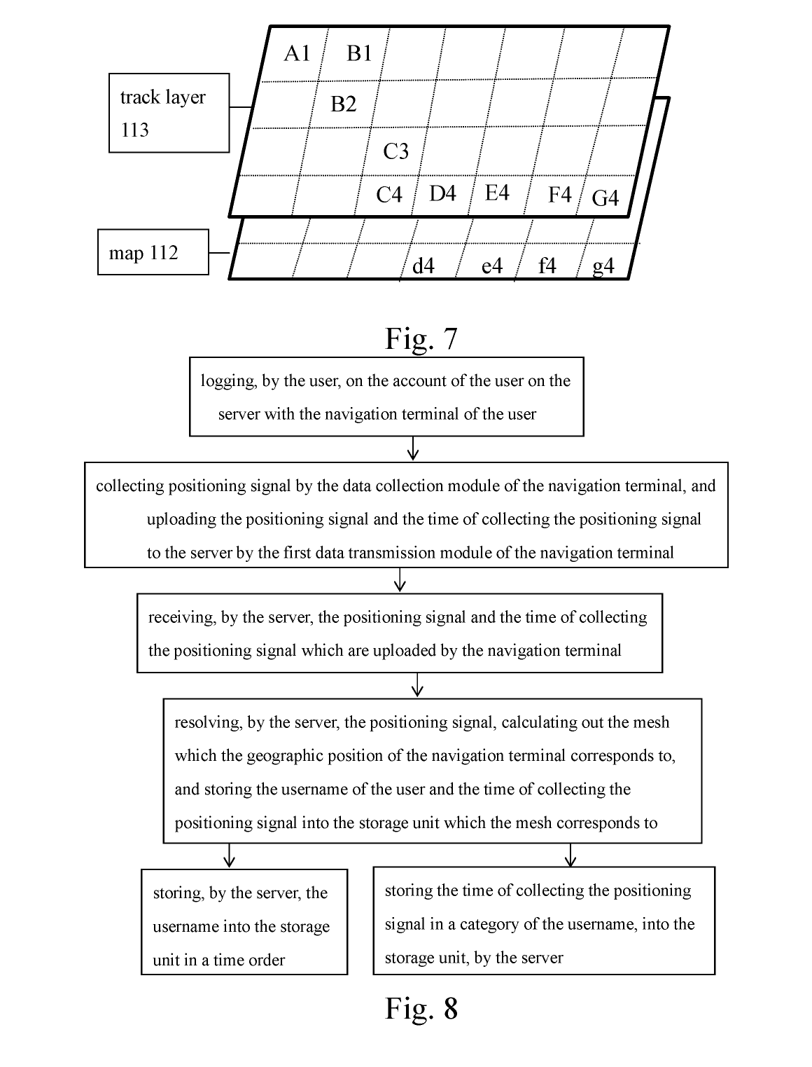

The track layer 113 corresponds to the map 112, for storing the user track data. In order to further illustrate a structure of the track layer, based on the first preferred embodiment, according to a second preferred embodiment of the present invention, the data collection module 21 is a GPS chip; referring to FIG. 7, the map 112 is divided into 4*7 geographic regions by net-shaped division lines, wherein: each grid corresponds to a single geographic region; the 4*7 storage units 1131 in the track layer correspond to the 4*7 grids. For example, the grid g4 corresponds to the storage unit G4. A number of the grids can be adjusted upon a positioning precision requirement; in the second preferred embodiment, the number of the grids is embodied to be 28, merely exemplary. The positioning data of the present invention is embodied to be the GPS positioning data in the second preferred embodiment of the present invention, but can be embodied as location based service (LBS) or Bluetooth positioning data in other preferred embodiments.

Referring to FIG. 8, the navigation advertisement pushing system based on the geographic positions stores the positioning data, comprising steps of: (1) logging, by the user 3, on the account 111 of the user 3 on the server 1 with the navigation terminal 2 of the user 3; (2) collecting GPS positioning signal by the data collection module 21 of the navigation terminal 2 of the user 3, and uploading the GPS positioning signal which is collected and the time of collecting the GPS positioning signal (the collecting time, for short) to the server 1 by the first data transmission module 23 of the navigation terminal 2 of the user 3; (3) receiving, by the server 1, the positioning signal and the collecting time which are uploaded by the navigation terminal 2; (4) resolving, by the server 1, the positioning signal, calculating out the grids which the geographic position of the navigation terminal 2 corresponds to, and storing the username 1111 of the user 3 and the collecting time into the storage unit 1131 which the grid corresponds to on the track layer 113; and (5) setting the username 1111 as a category and storing the collecting time into the category of the username 1111 corresponding to the user by the server 1; or, storing the username 1111 into the storage unit 1131 in a time order of the collecting time by the server 1.

As the conventional GPS track storage manner, the GPS signals or the coordinate data of the user are usually stored in the storage region inside the database under the account of the user in real-time. The conventional storage structure relatively favors replaying and revoking the GPS tracks of the users. However, the present invention requires rapidly calculating out the relevant user of some region on the map. If the server still successively revokes and analyzes the GPS tracks of all the users one by one, the conventional storage structure definitely results in an enormous calculation load and time delay. Through the technical solutions of the present invention, when the server calculates out the relevant users of one region, the server merely needs to calculate and analyze within the storage unit which the one region corresponds to, so as to rule out interference from many other relevant track data and reduce the calculation load on the server.

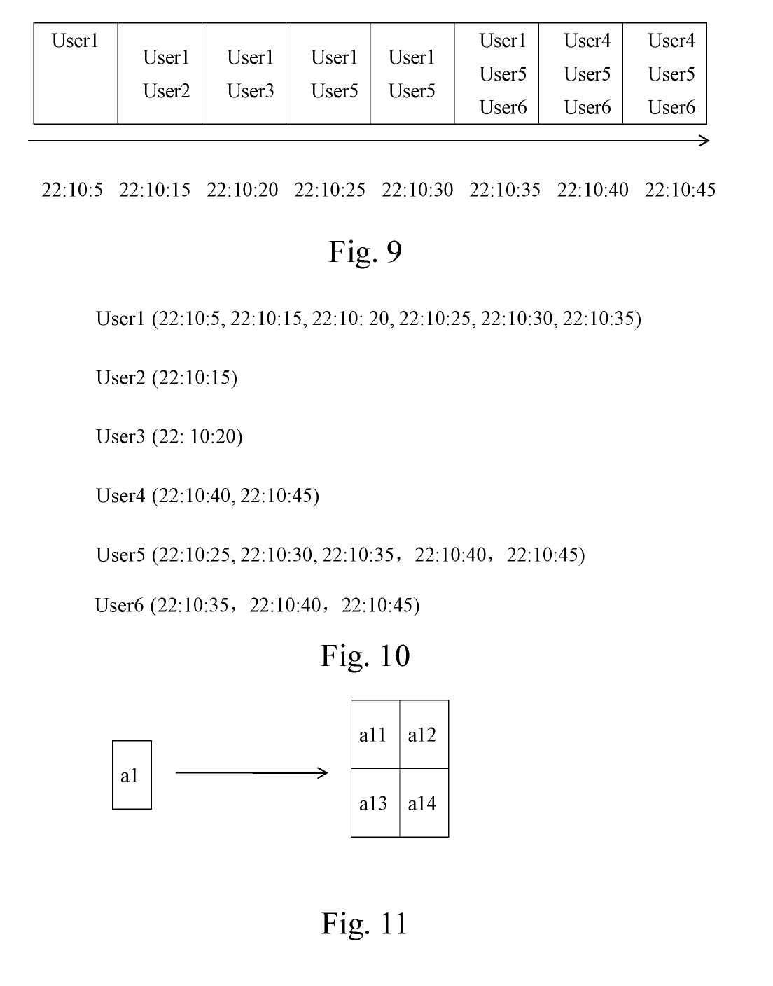

According to the second preferred embodiment of the present invention, referring to FIG. 9, the server 1 stores the username 1111 into the storage unit D3 in the time order of the collecting time; or, referring to FIG. 10, the server 1 stores the collecting time into the storage unit D3 in the category of the username 1111.

According to the second preferred embodiment of the present invention, the server 1 adjusts a user positioning precision by splitting and merging the grids. Referring to FIG. 11, the server 1 splits the grid al into four different geographic regions a11, a12, a13 and a14, respectively four grids; and then, the server 1 creates four storage units on the track layer 113 which respectively correspond to the four grids a11, a12, a13 and a14 after splitting, so as to raise the user positioning precision.

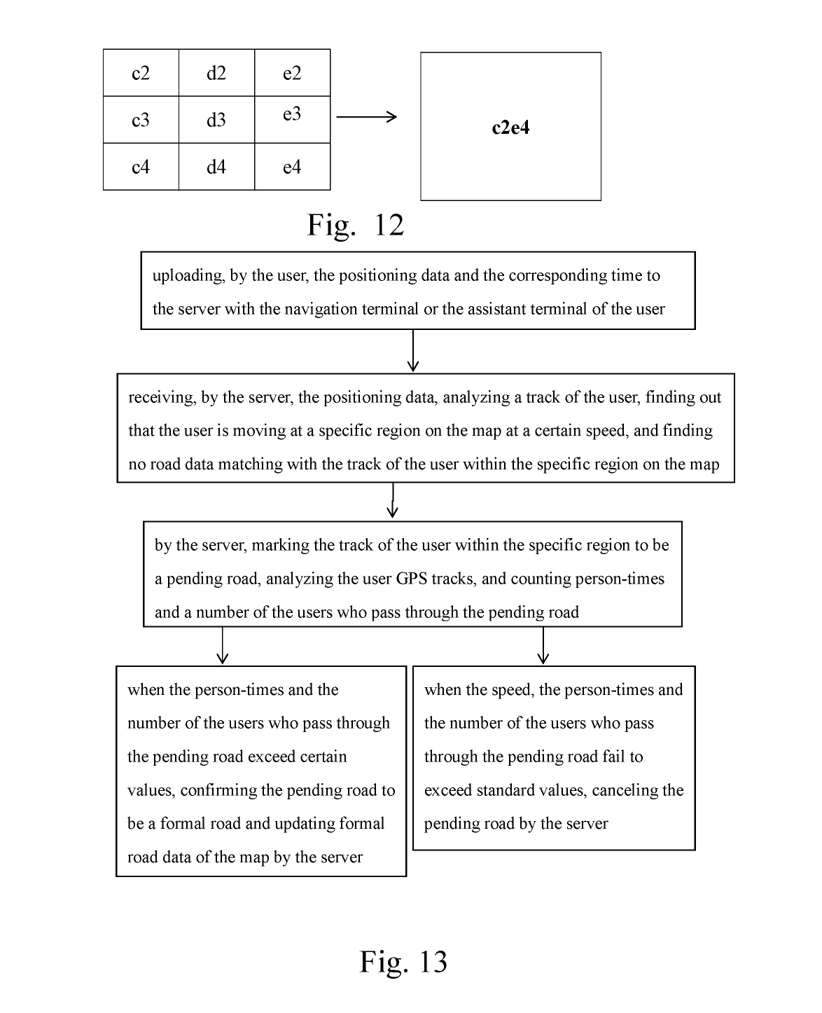

Referring to FIG. 12, the server 1 merges the nine neighboring grids c2, d2, e2, c3, d3, e3, c4, d4, and e4, into one grid c2e4; and accordingly, the server 1 merges the nine neighboring storage units 1131, on the track layer 113, which the nine neighboring grids correspond to, into one storage unit, so as to lower the user positioning precision. When the pushing region which the navigation advertisement 5, generated by the user 3, corresponds to is the grid c2e4, the server analyzes the user track data in the nine storage units C2 to E4, calculates and screens out the relevant users 31 whom the navigation advertisement 5 corresponds to.

An area of the geographic region which each grid corresponds to is preferably no larger than 4 square kilometers; therefore, in earth spherical area rectification, it is necessary to split the grid with the area larger than 4 square kilometers.

Referring to FIG. 13, according to the second preferred embodiment of the present invention, the navigation advertisement pushing system based on the geographic positions is further able to supplement the map 112 with road network data, comprising steps of:

(1) uploading, by the user 3, the positioning data and the time corresponding to the positioning data to the server 1 with the navigation terminal 2 of the user 3 or the assistant terminal 4 of the user 3; (2) receiving, by the server 1, the positioning data, analyzing a track of the user 3, finding out that the user is moving at a specific region on the map 112 at a certain speed, and finding no road data matching with the track of the user within the specific region on the map 112; (3) by the server, marking the track of the user 3 within the specific region to be a pending road, analyzing the user GPS tracks, and counting person-times and a number of the users who pass through the pending road; (4) when the person-times and the number of the users who pass through the pending road exceed certain values, confirming the pending road to be a formal road and updating formal road data of the map 112 by the server 1, wherein the certain values are preset by the server for different regions; (5) when the speed, the person-times and the number of the users who pass through the pending road fail to exceed standard values, canceling the pending road by the server 1.

In order to better illustrate the navigation advertisement pushing system based on the geographic positions, an application of the present invention in daily life is illustrated in a third preferred embodiment of the present invention. An employee a of a hotel A wants to distribute a promotion advertisement at an airport B, expecting pushing objects of the promotion advertisement to be: (1) passengers appearing at 21:00-23:00 pm; (2) not employees working at the airport B. The employee a of the hotel A distributes a navigation advertisement as follows:

(1) presetting the advertisement value combination for city F by the server, or presetting the advertisement value combination for a time period of 18:00-23:59 by the server, wherein a geographic region of the airport B belongs to a range of the city F; presetting, by the server, a user staying time to be an hour; (2) logging on the server, by the employee a, with the navigation terminal or the assistant terminal of the employee a; (3) setting, by the employee a, the navigation advertisement pushing region to be the airport B; (4) setting, by the employee a, the navigation destination coordinates to be coordinates of the hotel A on the map; (5) inputting detailed promotion advertisement main body, by the employee a, as the advertisement content, wherein the detailed promotion advertisement main body: standard room 30% off, now 100 yuan/day, welcome to check in the hotel; (6) selecting the type (4) of the relevant users and setting the time period in the type (4) to be 21:00-23:00, by the employee a; (7) selecting the type (5) of the relevant users and setting the second value to be 10, by the employee a;

wherein the employees working at the airport are supposed to appear at the airport for more than 10 times due to the track difference between the airport employees and the hotel employees; (8) selecting the logical calculation relationship NOT by the employee a, namely type (4) NOT type (5); (9) finishing the setting of the navigation advertisement by the employee a, and sending the navigation advertisement to the server by the employee a; (10) receiving the navigation advertisement by the server, calculating and screening out the relevant users whom the navigation advertisement corresponds to by the server; (11) at 22:01, pushing the navigation advertisement to a relevant user c by the server, and deducting, by the server, a first number of credits from the account of the user a, wherein the first number of the credits is the first advertisement value in the advertisement value combination for the city F or the first advertisement value in the advertisement value combination for the time period of 18:00-23:59; (12) by the relevant user c, receiving the navigation advertisement, selecting the advertisement recognition option, and submitting to the server; (13) automatically formulating, by the server, the navigation path to the navigation destination, the hotel A, for the relevant user c, and sending the navigation path to the relevant user c by the server; (14) by the relevant user c, receiving the navigation path and arriving at the hotel A at 22:45; (15) deducting, by the server, a second number of credits from the account of the employee a, wherein the second number of the credits is the second advertisement value in the advertisement value combination for the city F or the second advertisement value in the advertisement value combination for the time period 18:00-23:59; (16) analyzing the track of the relevant user c by the server, and finding that the relevant user c has stayed at the region of the hotel A for more than an hour, thereby presuming that the relevant user c has already grasped a full knowledge about a product offered by the hotel A and consumed; (17) deducting, by the server, a third number of credits from the account of the employee a, wherein the third number of the credits is the third advertisement value in the advertisement value combination for the city F or the third advertisement value in the advertisement value combination for the time period 18:00-23:59.

It is worth to mention that, after the relevant user c receives the navigation advertisement (after the step (11)), the relevant user c can give up selecting the advertisement recognition option 54 and go to the destination, the hotel A, directly in his/her own familiar path. When the server analyzes the track data of the relevant user c and finds out that the relevant user c has stayed at the region of the hotel A for more than an hour, the server directly deducts the third number of the credits from the account of the employee a, wherein the third number of the credits is the third advertisement value in the advertisement value combination for the airport B or the third advertisement value in the advertisement value combination for the time period which 22:01 belongs to.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A navigation advertisement pushing system based on geographic positions, comprising:
a server, a plurality of navigation terminals and a plurality of users corresponding to the plurality of the navigation terminals, wherein:
the server comprises a database which stores a map, a track layer for storing user track data, corresponding to the map, and a plurality of accounts corresponding to the plurality of the users, wherein: each user logs on the corresponding account on the server with the corresponding navigation terminal; each account comprises a username; the server is for dividing the map into a plurality of different grids with net-shaped division lines, and creating a storage unit on the track layer for each grid; wherein:
each navigation terminal comprises a data collection module, a first data storage module, and a first data transmission module; the data collection module is for collecting a positioning signal of the navigation terminal and a time of collecting the positioning signal in real-time; the first data storage module is for storing data, for further storing the positioning signal and the time of collecting the positioning signal; the first data transmission module is for transmitting the data between the navigation terminal and the server, for further sending the positioning signal and the time of collecting the positioning signal to the server; and
the server is further for receiving the positioning signal and the time of collecting the positioning signal, and calculating out coordinates of the positioning signal; the server is further for confirming the grid which the coordinates of the positioning signal correspond to on the map, and storing the username of the account on which the navigation terminal logs on the server and the time of collecting the positioning signal into the storage unit on the track layer which the grid corresponds to.

2. The navigation advertisement pushing system based on the geographic positions, as recited in claim 1, wherein the server is further for setting the username as a category and storing the time of collecting the positioning signal into the category of the username which the user corresponds to.

3. The navigation advertisement pushing system based on the geographic positions, as recited in claim 1, wherein the server is further for storing the username into the storage unit in a time order of the time of collecting the positioning signal.

4. The navigation advertisement pushing system based on the geographic positions, as recited in claim 3, wherein: the navigation terminal further comprises a first input and output module for receiving an input of the user and outputting to the user the data stored by the navigation terminal; the user inputs data with the first input and output module to generate a navigation advertisement, wherein the data inputted by the user comprise coordinates of a pushing region on the map; the server is further for receiving the navigation advertisement, calculating relevant users whom the pushing region corresponds to, and sending the navigation advertisement to the relevant users; the relevant users comprise at least one of the following eleven types:
(1) the users who mark out a familiar region on the map, wherein the familiar region comprises the pushing region;
(2) the users who appear in the pushing region at a frequency higher than a first value;
(3) the users who are appearing at the pushing region at a time of generating the navigation advertisement;
(4) within a time period which is designated by the user who generates the navigation advertisement, the users who are appearing at the pushing region;
(5) the users who appear at the pushing region at times more than a second value;
(6) the users who stay at the pushing region for a time longer than a third value;
(7) the users who appear at the pushing region at a time, wherein a difference between the time when the user appears at the pushing region and the time of generating the navigation advertisement is smaller than a fourth value;
(8) the users whose geographic positions are at a distance to a center of the pushing region, the distance smaller than a fifth value;
(9) the users who appear in the pushing region at a speed slower than a sixth value;
(10) the users who are empowered by the server to become the relevant users of a region, wherein the region comprises the pushing region; and
(11) the users who initiate a data search on a region of the map through the navigation terminal, wherein the region comprises the pushing region;
wherein the first value, the second value, the third value, the fourth value, the fifth value and the sixth value are designated by the user who generates the navigation advertisement.

5. The navigation advertisement pushing system based on the geographic positions, as recited in claim 4, wherein: the navigation terminal is further for logging on the account on the server and receiving the navigation advertisement; the server is for deducting a first number of credits from the account which generates the navigation advertisement, wherein the first number of the credits corresponds to a first advertisement value in an advertisement value combination for the pushing region of the navigation advertisement or a first advertisement value in an advertisement value combination for a time period which a time of pushing the navigation advertisement belongs to.

6. The navigation advertisement pushing system based on the geographic positions, as recited in claim 5, wherein the data inputted by the user further comprise an advertisement recognition option and coordinates of a navigation destination; the relevant user receives the navigation advertisement through the navigation terminal, selects the advertisement recognition option to generate advertisement invoking data, and uploads the advertisement invoking data to the server; the server calculates out a navigation path from a current position of the relevant user to the navigation destination, and sends the navigation path to the relevant user; the server is further for deducting a second number of credits from the account which generates the navigation advertisement, wherein the second number of the credits corresponds to a second advertisement value in the advertisement value combination for the pushing region of the navigation advertisement or a second advertisement value in the advertisement value combination for the time period which the time of pushing the navigation advertisement belongs to.

7. The navigation advertisement pushing system based on the geographic positions, as recited in claim 6, wherein the server is for detecting a duration or times for which the navigation terminal of the relevant user stays at a region of the navigation destination by calculating track data of the relevant user; when the server finds out that the duration or the times for which the navigation terminal of the relevant user stays at the region of the navigation destination exceeds or exceed a seventh value, the server is further for deducting a third number of credits from the account which generates the navigation advertisement, wherein the third number of the credits corresponds to a third advertisement value in the advertisement value combination for the pushing region of the navigation advertisement or a third advertisement value in the advertisement value combination for the time period which the time of pushing the navigation advertisement belongs to;
wherein the seventh value is preset by the server.

8. The navigation advertisement pushing system based on the geographic positions, as recited in claim 1, wherein the server is further for merging a plurality of the grids which are neighbor with each other into a single grid; the server merges the storage units on the track layer which the plurality of the grids, neighbor with each other, respectively correspond to, into a single storage unit, in such a manner that the single storage unit corresponds to the single grid.

9. The navigation advertisement pushing system based on the geographic positions, as recited in claim 1, wherein the server is further for splitting the grid into a plurality of grids with the net-shaped division lines again, and creating the storage unit on the track layer again for each of the plurality of the grids after splitting.

10. The navigation advertisement pushing system based on the geographic positions, as recited in claim 1, wherein the server is further for calculating and analyzing the user track data within a non-road region of the map, and when a number or person-times of the users who pass through the non-road region is larger than a ninth value, marking the non-road region as a road region;
wherein the ninth value is preset by the server.
